(19) United States
(12) Patent Application Publication
(10) Pub. No.: US 2020/0216589 A1
(43) Pub. Date: Jul. 9, 2020

(54) ADDITIVE MIXTURE

(71) Applicant: BASF SE, Ludwigshafen am Rhein (DE)

(72) Inventors: Sebastien VILLENEUVE, Kaisten (CH); Raphael DABBOUS, Kaisten (CH); Andreas STRUB, Kaisten (CH); Nazzareno RUGGERI, Basel (CH)

(73) Assignee: BASF SE, Ludwigshafen am Rhein (DE)

(21) Appl. No.: 16/647,907

(22) PCT Filed: Sep. 14, 2018
(86) PCT No.: PCT/EP2018/074874

§ 371 Date: Mar. 17, 2020

(30) Foreign Application Priority Data
Sep. 18, 2017 (EP) 17191665.3

(51) Int. Cl. C08F 210/14; C08F 234/02; C08L 37/00; C08L 23/20; B32B 27/32

(52) U.S. Cl. CPC C08F 210/14; C08F 234/02; C08L 37/00; C08L 23/20; B32B 27/322; B32B 2439/70; B32B 2250/40; B32B 2307/72; B32B 2250/242; B32B 2250/03; C08L 2207/066

(57) ABSTRACT

An additive mixture comprising (I) a copolymer having a number average molecular weight of 800 g/mol to 50 000 g/mol and containing recurring units of the formula (la) and (Ila) or recurring units of the formula (la) and (IIb), wherein the recurring units (la) and (Ila) can have a random, alternating or block distribution and the molar ratio of (la) to (Ila) is 1:10 to 10:1, the recurring units (la) and (lIb) can have a random, alternating or block distribution and the molar ratio of (la) to (lIb) is 1:10 to 10:1, the radicals R₁ independently of one another are C₁₀-C₃₀alkyl and the radicals R₂ independently of one another are hydrogen or C₁-C₃₀acyl, (II) a metal salt, preferably a transition metal salt, and (III) an oxidizable substrate, with the proviso that components (I) and (III) are different.

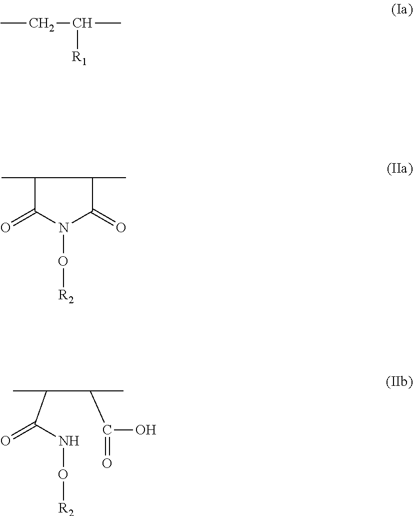

The present invention relates to an additive mixture containing a maleimide copolymer, a metal salt and an oxidizable substrate, a composition containing said additive mixture and the use of said additive mixture as oxygen scavenger.

In more detail, the present invention relates to an additive mixture comprising (I) a copolymer having a number average molecular weight of 800 g/mol to 50 000 g/mol and containing recurring units of the formula (Ia) and (IIa) or recurring units of the formula (Ia) and (IIb),

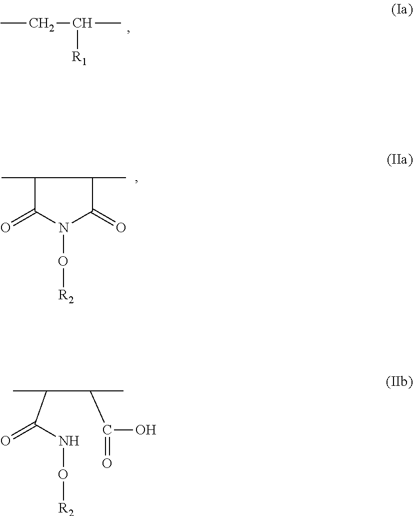

wherein

the recurring units (Ia) and (IIa) can have a random, alternating or block distribution and the molar ratio of (Ia) to (IIa) is 1:10 to 10:1, preferably 1:2 to 2:1,

the recurring units (Ia) and (IIb) can have a random, alternating or block distribution and the molar ratio of (Ia) to (IIb) is 1:10 to 10:1, preferably 1:2 to 2:1,

the radicals R₁ independently of one another are C₁₀-C₃₀alkyl and

the radicals R₂ independently of one another are hydrogen or C₁-C₃₀acyl,

(II) a metal salt, preferably a transition metal salt, and

(III) an oxidizable substrate,

with the proviso that components (I) and (III) are different.

Examples of C₁₀-C₃₀alkyl are decyl, undecyl, 1-methylundecyl, dodecyl, 1,1,3,3,5,5-hexamethylhexyl, tridecyl, tetradecyl, pentadecyl, hexadecyl, heptadecyl, octadecyl, eicosyl, docosyl and triacontyl.

Examples of acyl having up to 30 carbon atoms are C₂-C₃₀alkanoyl, C₃-C₃₀alkenoyl and unsubstituted or substituted benzoyl. C₁₀-C₃₀alkanoyl and C₁₀-C₃₀alkenoyl are preferred. Acetyl, propionyl, butyryl, pentanoyl, hexanoyl, octanoyl, benzoyl, acryloyl and crotonoyl are more specific examples. Dodecanoyl, hexadecanoyl, octadecanoyl, octadec-9-enoyl, octadeca-9,12-dienoyl and octadeca-9,12,15-trienoyl are further specific examples.

R₂ preferably is hydrogen, C₁₀-C₃₀alkanoyl or C₁₀-C₃₀alkenoyl, in particular hydrogen or C₁₆-C₂₄alkanoyl, in particular hydrogen or stearoyl.

Component (II) preferably is an organic salt of Fe, Co, Ce, Mn, Cu, Ni or Vd, in particular of Cu, Co or Mn.

According to a further preferred embodiment component (II) is a metal salt of a C₆-C₃₆-carboxylic acid such as lauric acid, palmitic acid, stearic acid, oleic acid, linoleic acid and linolenic acid.

According to a particular preferred embodiment component (II) is Mn stearate.

Component (III) is preferably a sacrificial oxidizable substrate, and more preferably selected from the group consisting of polybutadiene, polyester, terpene and polyterpene resins (among others squalene, poly-limonene, poly alpha-pinene, poly beta-pinene), squalane, polystyrene, poly-norbornene and linear or branched alkene chain C₆-C₃₀alcohols.

According to a further preferred embodiment component (III) is a polyterpene resin, in particular a polyterpene based on an alpha-pinene or a beta-pinene.

The polyterpene resins are for example based on acyclic terpenes or cyclic terpenes, e.g. monocyclic terpenes or bicyclic terpenes. Polyterpenes based on terpene hydrocarbons are preferred.

Terpene-based hydrocarbon resins are typically based on products such as alpha-pinene, beta-pinene and d-limonene, which are obtained from the wood and citrus industry, respectively. Terpene-based resins have been available since the mid-1930s (Kirk-Othmer, Encyclopedia of Chemical Technology, John Wiley & Sons, 4. ed. (1994), Vol. 13, p. 717-718). Polymerization of monoterpenes is most commonly accomplished by carbocationic polymerization utilizing Friedel-Crafts-type catalyst systems, such as aluminum chloride (Kirk-Othmer, Encyclopedia of Chemical Technology, John Wiley & Sons, 4. ed. (1994), Vol. 1, p. 459).

Examples of acyclic terpenes are

terpene hydrocarbons, e.g. myrcene, ocimene, 2,6-Dimethyl-2,4,6-octatriene (4E, 6E and 4E, 6Z steteoisomers), phytol, squalene, alpha-farnesene and beta-farnesene;

terpene alcohols, e.g. dihydromyrcenol (2,6-dimethyl-7-octen-2-ol), geraniol (3,7-dimethyl-trans-2,6-octadien-1-ol), tetrahydrogeraniol (3,7-dimethyloctan-1-ol), nerol (3,7-dimethyl-cis-2,6-octadien-1-ol), linalool (3,7-dimethyl-1,6-octadien-3-ol), myrcenol (2-methyl-6-methylene-7-octen-2-ol), tetrahydrolinalool (3,7-dimethyloctan-3-ol), lavandulol, citronellol (3,7-dimethyl-6-octen-1-ol), trans-trans-farnesol (3,7,11-trimethyl-2,6,10-dodecatrien-1-ol) and trans-nerolidol (3,7,11-trimethyl-1,6,10-dodecatrien-3-ol);

terpene aldehydes and acetals, e.g. citral (3,7-dimethyl-2,6-octadien-1-al), citral dimethyl acetal (1,1-dimethoxy-3,7-dimethylocta-2,6-diene), methoxydihydrocitronellal (3,7-dimethyl-7-methoxyoctan-1-al), hydroxydihydrocitronellal (3,7-dimethyl-7-hydroxyoctan1-al), hydroxydihydrocitronellal dimethylacetal (8,8-dimethoxy-2,6-dimethyloctan-2-ol), citral diethyl acetal (3,7-dimethyl-2,6-octadien-1-aldiethyl acetal), citronellal (3,7-dimethyl-6-octen-1-al), citronellyloxyacetaldehyde and 2,6,10-trimethyl-9-undecenal;

terpene ketones, e.g. tagetone, solanone and geranylacetone (6,10-dimethyl-5,9-undecadien-2-one);

terpene acids and esters, e.g. cis-geranic acid, citronellic acid, geranyl esters (including geranyl formate, geranyl acetate, geranyl propionate, geranyl isobutyrate, geranyl phenylacetate and geranyl isovalerate), neryl esters (including neryl acetate), linalyl esters (including linalyl formate, linalyl acetate, linalyl propionate, linalyl butyrate and linalyl isobutyrate), lavandulyl esters (including lavandulyl acetate), citronellyl esters (including citronellyl formate, citronellyl acetate, cintronellyl propionate, citronellyl isobutyrate, citronellyl isovalerate and citronellyl tiglate); and

nitrogen containing unsaturated terpene derivatives, e.g. cis-geranic acid nitrile and citronellic acid nitrile.

Examples of cyclic terpenes are

cyclic terpene hydrocarbons, e.g. limonene (1,8-p-methadiene), alpha-terpinene, beta-terpinene, gamma-terpinene (1,4-p-menthadiene), terpinolene, alpha-phellandrene (1,5-p-menthadiene), beta-phellandrene, alpha-pinene (2-pinene), beta-pinene (2(10)-pinene), camphene, 3-carene, caryophyllene, (+)-valencene, thujopsene, alpha-bisabolene, beta-bisabolene, gamma-bisabolene, alpha-cedrene, beta-cedrene and longifolene;

cyclic terpene alcohols and ethers, e.g. (+)-neoiso-isopulegol, isopulegol (8-p-menten-3-ol), pinanol (2,6,6-bicycloheptan-2-ol) as cis or trans isomer, alpha-terpineol (1-p-menten-8-ol), beta-terpineol, gamma-terpineol, delta-terpineol, bisabolol (+ and − isomers) and 1-terpinen-4-ol (1-p-menten-4-ol);

cyclic terpene aldehydes and ketones, e.g. carvone (1,8-p-mantadien-6-one), alpha-ionone (C₁₃H₂₀O), beta-ionone (C₁₃H₂₀O), gamma-ionone (C₁₃H₂₀O), irone (alpha-, beta-, gamma-) (C₁₄H₂₂O), n-methylionone (alpha-, beta-, gamma-) (C₁₄H₂₂O), isomethylionone (alpha-, beta-, gamma-) (C₁₄H₂₂O), allylionone (C₁₆H₂₄O), pseudoionone, n-methylpseudoionone, isomethylpseudoionone, damascones (1-(2,6,6-trimethylcycohexenyl)-2-buten-1-ones; including beta-damascenone (1-(2,6,6-trimethyl-1,3-cyclohadienyl)-2-buten-1-one)), nootkatone (5,6-dimethyl-8-isopropenylbicyclo[4.4.0]-1-decen-3-one) and cedryl methyl ketone (C₁₇H₂₆O); and

cyclic terpene esters, e.g. alpha-terpinyl acetate (1-p-menthen-8-yl acetate), nopyl acetate ((−)-2-(6,6-dimethylbicyclo[3.1.1]hept-2-en-2-yl)ethyl acetate) and khusymil acetate.

Further suitable terpene derivatives can be found in Kirk-Othmer, Encyclopedia of Chemical Technology, John Wiley & Sons, 4. ed. (1994), Vol. 23, p. 833-882 and in the Ullmann Encyclopedia of Industrial Chemistry, Wiley-VCH Verlag GmbH and Co KGaA, 2012.

Preferred examples of terpenes which can serve as the basis for the polyterpenes are tricyclene, alpha-pinene, alpha-fenchene, camphene, beta-pinene, myrcene, cis-pinane, trans-pinane, cis/trans-p-8-menthene, trans-2-p-menthene, p-3-menthene, trans-p-menthane, 3-carene, cis-p-menthane, 1,4-cineole, 1,8-cineole, alpha-terpinene, beta-terpinene, p-1-menthene, p-4(8)-menthene, limonene, p-cymene, gamma-terpinene, p-3,8-menthadiene, p-2,4(8)-menthadiene and terpinolene.

Further examples of component (III) are cycloaliphatic compounds structurally related to terpenes such as the following alcohols, e.g. 5-(2,2,3-trimethyl-3-cyclopenten-1-yl)-3-methylpentan-2-ol;

aldehydes, e.g. 2,4-dimethyl-3-cyclohexene carboxaldehyde, 4-(4-methyl-3-penten-1-yl)-3-cyclohexene carboxaldehyde and 4-(4-hydroxy-4-methylpentyl)-3-cyclohexene carboxaldehyde;

ketones, e.g. civetone, dihydrojasmone (3-methyl-2-pentyl-2-cyclopenten-1-one), cis-jasmone (3-methyl-2-(2-cis-penten-1-yl)-2-cyclopenten-1-one), 5-cyclohexadecen-1-one, 2,3,8,8-tetramethyl-1,2,3,4,5,6,7,8-octahydro-2-napthalenyl methyl ketone and 3-methyl-2-cyclopenten-2-ol-1-one; and

esters, e.g. 4,7-methano-3a,4,5,6,7,7a-hexahydro-5-(or 6)-indenyl acetate, allyl 3-cyclohexylpropionate, methyl dihydrojasmonate methyl (3-oxo-2-pentylcyclopentyl) acetate.

The polyterpenes used in the present invention may also be derived from the copolymerisation of the aforementioned terpenes with other unsaturated organic compounds.

Other examples of component (III) are the unsaturated coal-tar by-product polymers such as cumarone-indene resins, rosin and the like.

Present component (III) is preferably a polyterpene resin selected from the group consisting of poly-alpha-pinene, poly-beta-pinene, polylimonene or a copolymer of alpha-pinene, a copolymer of beta-pinene or a copolymer of limonene.

In general, the polyterpenes of the present invention have more than one terpene unit. They have preferably a molecular weight of about 400 g/mol to about 50 000 g/mol.

The weight ratio of component (I) to component (II) preferably is 1:10 to 10:1, more preferably 1:2 to 2:1.

The weight ratio of component (I) to component (III) preferably is 1:50 to 1:1 and more preferably 1:25 to 1:5.

A further embodiment of the present invention is a composition containing components (A), (B) and optionally (C), wherein

(A) is a polymeric resin, preferably a thermoplastic polymeric resin,

(B) is the additive mixture as described above, and

(C) is a further additive, preferably an additive selected from the group consisting of nucleating agents, clarifiers, fillers, reinforcing agents, pigments, dyestuffs, light stabilizers, antioxidants, antifogging agents, antislip or antiblock additives, plasticizers, flame retardants, optical brighteners, photoinitiators, antistatic agents and blowing agents,

with the proviso that the additives of components (B) and (C) are different.

The pigment preferably is titanium dioxide and the clarifier preferably is a sorbitol, an organic phosphate salt or a trisamide.

Examples of component (A) are:

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or poly-butadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimides, polyesterimides, polyhydantoins and polybenzimidazoles.

18. Polyesters derived from dicarboxylic acids and diols and/or from hydroxycarboxylic acids or the corresponding lactones or lactides, for example polyethylene terephthalate, polybutylene terephthalate, poly-1,4-dimethylolcyclohexane terephthalate, polyalkylene naphthalate and polyhydroxybenzoates as well as copolyether esters derived from hydroxyl-terminated polyethers, and also polyesters modified with polycarbonates or MBS. Copolyesters may comprise, for example—but are not limited to—polybutyl-enesuccinate/terephtalate, polybutyleneadipate/terephthalate, polytetramethyleneadipate/terephthalate, polybutylensuccinate/adipate, polybutylensuccinate/carbonate, poly-3-hydroxybutyrate/octanoate copolymer, poly-3-hydroxybutyrate/hexanoate/decanoate terpolymer. Furthermore, aliphatic polyesters may comprise, for example—but are not limited to—the class of poly(hydroxyalkanoates), in particular, poly(propio-lactone), poly(butyrolactone), poly(pivalolactone), poly(valerolactone) and poly(caprolactone), polyethylenesuccinate, polyethylenefuranoate, polypropylenesuccinate, polybutylenesuccinate, polyhexamethylenesuccinate, polyethyleneadipate, polypropyleneadipate, polybutyleneadipate, polyhexamethyleneadipate, polyethyleneoxalate, polypropyleneoxalate, polybutyleneoxalate, polyhexamethyleneoxalate, polyethylenesebacate, polypropylenesebacate, polybutylenesebacate and polylactic acid (PLA) as well as corresponding polyesters modified with polycarbonates or MBS. The term “polylactic acid (PLA)” designates a homo-polymer of preferably poly-L-lactide and any of its blends or alloys with other polymers; a co-polymer of lactic acid or lactide with other monomers, such as hydroxy-carboxylic acids, like for example glycolic acid, 3-hydroxy-butyric acid, 4-hydroxy-butyric acid, 4-hydroxy-valeric acid, 5-hydroxy-valeric acid, 6-hydroxy-caproic acid and cyclic forms thereof; the terms “lactic acid” or “lactide” include L-lactic acid, D-lactic acid, mixtures and dimers thereof, i.e. L-lactide, D-lactide, meso-lacide and any mixtures thereof.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

Component (A) is preferably selected from the group consisting of homo- or copolymers of olefin monomers, copolymers of olefin monomers with diolefin monomers, cyclic olefins, copolymers of one or more 1-olefins and diolefins with carbon monoxide, polyvinyl alcohol, polyamide, polybutylene terephthalate, polyethylene terephthalate, poly(butylene adipate-co-terephthalate) and polybutylene succinate, in particular from the group consisting of acrylates, urethanes, epoxies, polyesters, polystyrenics, polybutadiene, polyisoprene and their copolymers.

The additive mixture of component (B) is preferably present in the composition according to the present invention in an amount of 0.001 to 20%, preferably 0.01 to 10%, in particular 1 to 5%, relative to the weight of component (A).

Examples of component (C) are:

1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclo-hexylphenol, 2,6-di-tert-butyl-4-methoxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methylpentadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methyl phenol, 2,4-dioctylthiomethyl-6-ethyl phenol, 2,6-di-do-decylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-di-phenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy2-methylphenyl)-4-n-dodecylmercaptobutane, 1,1,5,5-tetra-(5-tert-butyl-4-hydroxy-2-methylphenyl)pentane.

1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.

1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis (3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.

1.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxy-anilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxy-ethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxy-ethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]undecane.

1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodeca-noylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

2. UV Absorbers and Light Stabilizers

2.1. 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhex-yloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

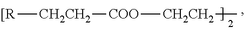

where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethyl-butyl)-phenyl]benzotriazole; 2-[2′-hydroxy-3′-(1,1,3,3-tetramethylbutyl)-5′-(α,α-dimethylbenzyl)-phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(β-carbomethoxy-p-cyanovinyl)-2-methylindoline, neopentyl tetra(α-cyano-β,β-diphenylacrylate.

2.5. Nickel compounds, for example nickel complexes of 2,2′-thio-bis[4-(1,1,3,3-tetra-methylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example 1,6-Hexanediamine N, N′-bis(1-propyloxy-2,2,6,6-tetramethyl-4-piperidinyl)-N, N′-bis-2-[4,5-bis-(N-n-butyl-N′-1-propyloxy-2,2,6,6-tetramethyl-4-piperidinyl)-1,3,5-triazine], 1,6-Hexanediamine N, N′-bis(2,2,6,6-tetramethyl-4-piperidinyl)-N, N′-bis-2-[4,5-bis-(N-n-butyl-N′-2,2,6,6-tetramethyl-4-piperidinyl)-1,3,5-triazine], carbonic acid bis(1-undecyloxy-2,2,6,6-tetra-methyl-4-piperidyl)ester, bis(2,2,6,6-tetramethyl-4-piperidyl)sebacate, bis(2,2,6,6-tetramethyl-4-piperidyl)succinate, Reaction products of alkanoic acid(C=18,20,22,24, normal chain) and 1,2,2,6,6-pentamethylpiperidin-4-ol, which consist of 1,2,2,6,6-pentamethylpiperidine-4-yl docosanoate as a major component (80% or more), bis(1,2,2,6,6-pentamethyl-4-piperidyl)sebacate, bis(1-undecanoxy-2,2,6,6-tetra-methylpiperidin-4-yl)carbonate (CAS Reg. No. [705257-84-7], bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)-ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)oxymethyl-3,3,5-trimethyl-2-morpholinone, Sanduvor (Clariant; CAS Reg. No. 106917-31-1], aminoether HALS/Polymer Hostavin NOW Pills XP (Clariant; CAS Reg. No. [942926-88-7], 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-aminopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)-amino)-s-triazine,

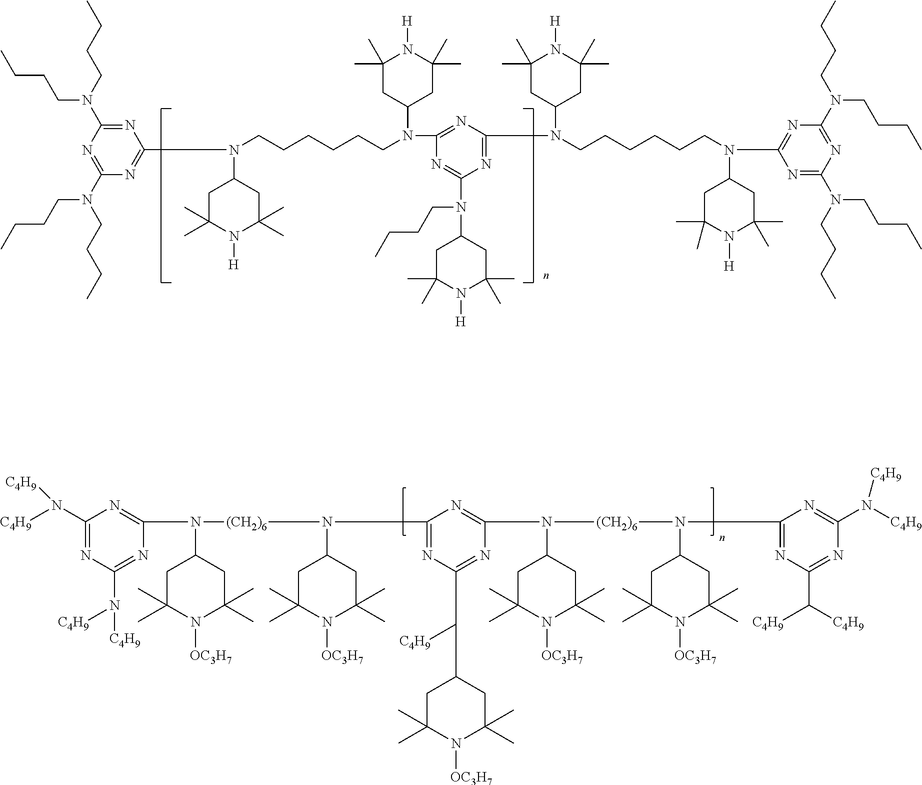

2.7 Benzoxazinone derivatives such as e.g. 2,2′-(1,4-phenylene)bis[4H-3,1-benzoxazin-4-one] (CAS No. 018600-59-4).

2.8. Oxamides, for example 4,4′-dioctyloxyoxanilide, 2,2′-diethoxyoxanilide, 2,2′-di-octyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.9. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-do-decyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-di-phenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(4-[2-ethylhexyloxy]-2-hydroxyphenyl)-6-(4-methoxyphenyl)-1,3,5-triazine, 2-(4,6-bis-biphenyl-4-yl-1,3,5-triazin-2-yl)-5-(2-ethyl-(n)-hexyloxy)phenol.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

3a. Formamidines, for example Ethoxycarbonylphenyl)-N′-ethyl-N′-phenyl formamidine.

4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-bi phenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, phosphorus acid, mixed 2,4-bis(1,1-dimethylpropyl)phenyl and 4-(1,1-dimethyl)phenyltriesters (CAS Reg. No. [939402-02-5], Phosphorus acid, triphenyl ester, polymer with alpha-hydro-omega-hydroxypoly[oxy(methyl-1,2-ethanediyl)], C₁₀₋₁₆ alkyl esters (CAS Reg. No. [1227937-46-3].

The following phosphites are especially preferred:

Tris(2,4-di-tert-butylphenyl) phosphite (Irgafos® 168, BASF SE), tris(nonylphenyl) phosphite, phosphorus acid mixed 2,4-bis(1,1-dimethylpropyl)phenyl and 4-(1,1-dimethylpropyl)phenyl triesters (CAS Reg. No. 939402-02-5), phosphorous acid triphenyl ester polymer with alpha-hydro-omega-hydroxypoly[oxy(methyl-1,2-ethanediyl) C10-16 alkyl esters (CAS Reg. No. 1227937-46-3).

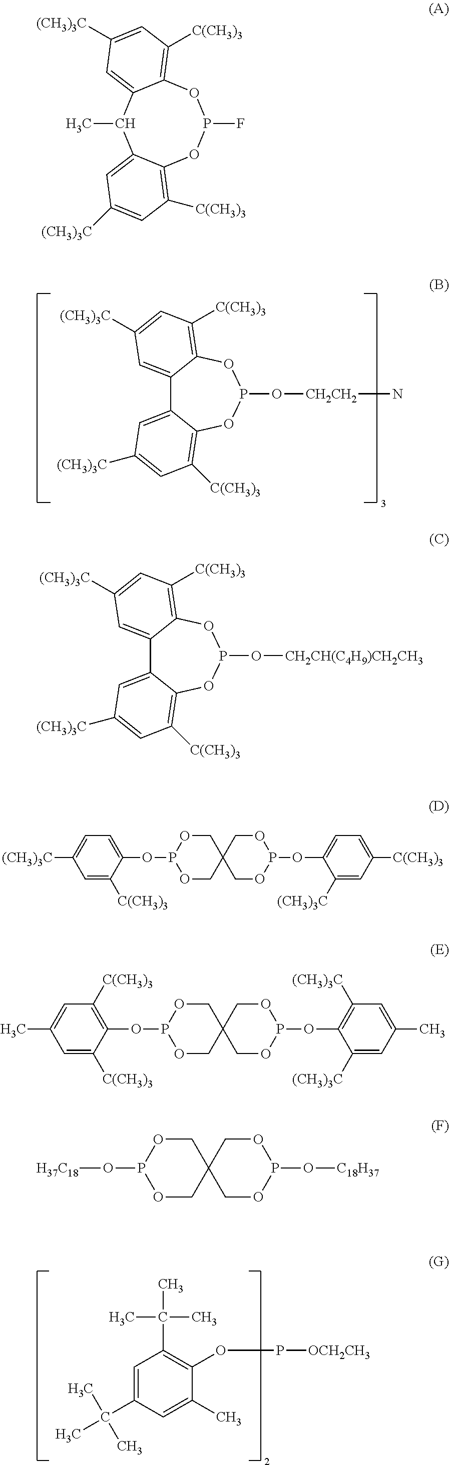

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.

6. Amine oxides, for example N,N-dibenzylhydroxylamine oxide, N,N-diethylhydroxylamine oxide, N,N-dioctylhydroxylamine oxide, N,N-dilaurylhydroxylamine oxide, N,N-ditetradecylhydroxylamine oxide, N,N-dihexadecylhydroxylamine oxide, N,N-dioctadecylhydroxylamine oxide, N-hexadecyl-N-octadecylhydroxylamine oxide, N-heptadecyl-N-octadecylhydroxylamine oxide, N,N-dialkylhydroxylamine oxide derived from hydrogenated tallow amine.

7. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.

8. Thiosynergists, for example dilauryl thiodipropionate, dimistryl thiodipropionate, distearyl thiodipropionate, pentaerythritol tetrakis[3-(dodecylthio)propionate] or distearyl disulfide.

9. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.

10. Polyamide stabilizers, for example copper salts in combination with iodides and/or phosphorus compounds and salts of divalent manganese.

11. Basic co-stabilizers, for example melamine, polyvinylpyrrolidone, dicyandiamide, tri-allyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate, zeolithes, hydrotalcites, hydrocalumites.

12. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers), sorbitols, nonitols. Especially preferred are 1,3:2,4-bis(3′,4′-dimethylbenzylidene)sorbitol, 1,3:2,4-di(paramethyldibenzylidene)sorbitol, and 1,3:2,4-di(benzylidene)sorbitol.

13. Fillers and reinforcing agents, for example calcium carbonate, silicates, glass fibres, carbon fibers, glass beads, asbestos, talcum (preferably with a particle size of 0.01 to 20 μm), kaolin, mica, barium sulfate, metal oxides and hydroxides, carbon black, graphite, wood flour and flours or fibers of other natural products, synthetic fibers.

14. Other additives, for example plasticisers, lubricants, emulsifiers, colorants, pigments, titanium dioxide, rheology additives, catalysts, flow-control agents, optical brighteners, flameproofing agents, antistatic agents and blowing agents.

15. Benzofuranones and indolinones, for example those disclosed in U.S. Pat. Nos. 4,325,863; 4,338,244; 5,175,312; 5,216,052; 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzo-furan-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctylbenzofuran-2-one.

Component (C) is preferably present in the composition according to the present invention in an amount of 0.0025 to 30%, preferably 0.01 to 20%, in particular 0.05-10%, relative to the weight of component (A).

In the case where component (C) is a filler, a fiber or an inorganic pigment, it is preferably present in the composition according to the present invention in an amount of 0.5% to 80%, relative to the weight of component (A).

The above-mentioned compositions containing the component (B) are preferably used in one of the following processes: injection blow molding, extrusion, blow molding, rotomolding, in mold decoration (back injection), slush molding, injection molding, co-injection molding, blow molding, forming, compression molding, resin transfer molding, pressing, film extrusion (cast film; blown film), fiber spinning (woven, non-woven), drawing (uniaxial, biaxial), annealing, deep drawing, calandering, mechanical transformation, sintering, coextrusion, coating, lamination, crosslinking (radiation, peroxide, silane), vapor deposition, weld together, glue, vulcanization, thermoforming, pipe extrusion, profile extrusion, sheet extrusion; sheet casting, spin coating, strapping, foaming, recycling/rework, extrusion coating, visbreaking (peroxide, thermal), fiber melt blown, spun bonded, surface treatment (corona discharge, flame, plasma), sterilization (by gamma rays, electron beams), gel-coating, tape extrusion, pultrusion, SMC-process or plastisol.

Typically, the additive mixture according to the present invention (component B) is incorporated in the polymer matrix in individual form or, more preferably, through the preparation of a masterbatch that generally speaking is a concentrate of additives, subsequently used, for practical reasons, to obtain the final articles with the desired concentration. The masterbatch contains the component B in a concentration of 1.5 to 70%, in particular 2.5 to 25%, by weight; in such operations, the polymer can be used in the form of powder, granules, solutions, suspensions or in the form of lattices. The additive mixture according to the present invention (component B) can be used alone or in combination with other types of additives, in this latter case either in individual form or using several masterbatches, or using a single “combi-masterbatch”, in the preparation of the final article.

A further embodiment of the present invention is a shaped polymer article made of the composition described above. The shaped polymer article preferably is a film, a tape, a sheet, a laminate, an injection molded article, a blow molded article, a thermoformed article, a particle (powder) or a fiber, in particular an extruded film or a coextruded multilayer film.

Another embodiment of the present invention is the use of the additive mixture according to the present invention as oxygen scavenger, dispersant, compatibilizer, coupling agent, antistatic additive, oxygen barrier additive, water vapor barrier additive, pour-point depressant, flow modifier for crude oil, dish-washing detergent, antifouling agent in water systems, binder, metal deactivator or thermal stabilizer, preferably as oxygen scavenger.

The present additive mixture is in particular an oxygen scavenging mixture.

Thus, another object of the present invention is to provide improved oxygen-scavenging compositions and packagings. A further object is to provide oxygen scavenging compositions that can be used effectively, even at relatively low levels, in a wide range of active-barrier packaging films and sheets, flexible or rigid, including laminated and coextruded multilayer films and sheets. The object is to provide active-barrier packaging containers that can increase the shelf-life of oxygen-sensitive products by slowing the passage of external oxygen into the container, by absorbing oxygen present inside the container or both. Other objects will be apparent to those skilled in the art. Thus, food packaging is particularly of interest.

A further embodiment of the present invention is a copolymer having a number average molecular weight of 800 g/mol to 50 000 g/mol and containing recurring units of the formula (Ia) and (IIa) or recurring units of the formula (Ia) and (IIb),

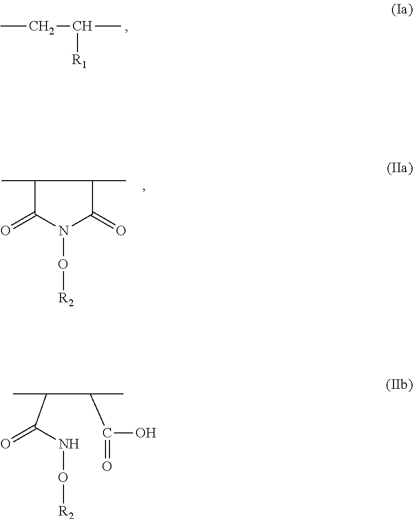

wherein

the recurring units (Ia) and (IIa) can have a random, alternating or block distribution and the molar ratio of (Ia) to (IIa) is 1:10 to 10:1,

the recurring units (Ia) and (IIb) can have a random, alternating or block distribution and the molar ratio of (Ia) to (IIb) is 1:10 to 10:1,

the radicals R₁ independently of one another are C₁₀-C₃₀alkyl and

the radicals R₂ independently of one another are hydrogen or C₁-C₃₀acyl,

with the proviso, that R₂ is not hydrogen in the recurring unit of formula (IIa).

Preference is given to recurring units of formulae (IIa) and (IIb), wherein in each case R₂ is C₁-C₃₀acyl.

The examples below illustrate the invention in greater detail. All percentages and parts are by weight, unless stated otherwise.

The molecular weights Mw and Mn are determined by GPC (Gel Permeation Chromatography) in THF (tetrahydrofurane), using polystyrene as standard for calibration. GPC is used as an analytical procedure for separating molecules by their difference in size and to obtain molecular weight averages (the number average molecular weight Mn and the weight average molecular weight Mw) or information on the molecular weight distribution of polymers. The technique is well known and described, for instance, in “Modern Size-Exclusion Liquid Chromatography” by W. W. Yan et al., edited by J. Wiley & Sons, N.Y., USA, 1979, pages 4-8, 249-283 and 315-340.

The GPC analyses shown in the following Examples are carried out with a GPC chromatograph equipped with an RI detector. The analyses are carried out at 35° C. (step 1) resp. 40° C. (step 2) by using three columns Plgel 5 μm (modified styrene-divinylbenzene-copolymer network), with limits at 500 g/mol and 10 000 000 g/mol (for step 1) resp. PSS SDV 5 μm, with limits at 1 000 g/mol and 1 000 000 g/mol (for step 2). THF is used as eluent (flow 1.0 ml/min for both steps) and the samples are dissolved for step 1 in THF+0.1% trifluoroacetic acid (2 g/l) resp. in THF only (1 g/l) for step 2.

### EXAMPLE 1: PREPARATION OF 1:1 N-HYDROXY-MALEIMIDE/C₁₈-C₂₂ALK-1-ENE COPOLYMER

(Product 1)

1:1 maleic anhydride/C₁₈-C₂₂alk-1-ene copolymer applied:

Composition of the C₁₈-C₂₂ alk-1-ene: Octadec-1-ene (1%), eicos-1-ene (49%), docos-1-ene (42%), tetracos-1-ene (8%) and hexacos-1-ene (<0.1%).

Weight average molecular weight Mw: 9900 g/mol

Number average molecular weight Mn: 3350 g/mol

1H-NMR (CDCl3, 300 MHz, δ [ppm]): δ 0.87-0.92 (—CH3, taken as reference signal, taking a degree of polymerization of 10 (based on the GPC data from hereabove), peak surface=36 a.u.), δ 1.27-1.33 (—CH2— and —CH—, peak surface=338 a.u.).

Melting point: 52.1° C. (DSC measurement, under nitrogen, heating rate 10 K/min).

400 g of the 1:1 maleic anhydride/C₁₈-C₂₂alk-1-ene copolymer are dissolved in 1500 ml of toluene and subsequently 67.4 g of hydroxylamine are added. The obtained suspension is heated to 40° C. Then 99.5 g of triethylamine are added. The mixture is stirred during two hours at 40° C., then two more hours at 80° C. and then two more hours at 90° C. The mixture is cooled down to room temperature, filtered and washed with water. The toluene is evaporated (drying over Na₂SO₄ and concentrated in a Rotavapor at 90° C. under high vacuum to give 427 g of a solid powdery product (theoretical mass=430 g).

1H-NMR (CDCl3, 300 MHz, δ [ppm]): δ 0.87-0.92 (—CH3, taken as reference signal, peak surface=36 a.u.), δ 1.27-1.40 (—CH2- and —CH—, peak surface=346 a.u.).

Weight average molecular weight Mw: 15 600 g/mol Number average molecular weight Mn: 3 310 g/mol.

### EXAMPLE 2: PREPARATION OF 1:1 N-STEAROYLOXY-MALEIMIDE/C₁₈-C₂₂ALK-1-ENE COPOLYMER

(Product 2)

170 g of Product 1 according to Example 1 are dissolved in 1000 ml of tetrahydrofuran. Then 49.0 g of triethylamine are added. Subsequently 122.1 g of stearoyl chloride dissolved in 20 ml of tetrahydrofuran are added dropwise over 30 minutes. The mixture is stirred at room temperature over night. The obtained product is filtered and concentrated in a Rotavapor to give 240 g of a powdery solid product.

1H-NMR (CDCl3, 300 MHz, δ [ppm]): δ 0.87-0.93 (—CH3, taken as reference signal, peak surface=66 a.u.), δ 1.27-1.45 (—CH2- and —CH—, peak surface=531 a.u.). The signal at shift between 1.27 and 1.45 ppm is clearly higher than for the starting products and corresponds to the expected value due to the addition of the stearyl chain.

Weight average molecular Mw: 53 400 g/mol

Number average molecular weight Mn: 2 000 g/mol.

Melting point: 49.9° C.

### EXAMPLE A

The polymer used is low density polyethylene (LDPE) of melt flow index of 8 g/10 min (190° C., 2.16 kg) and density of 0.919 g/cm³. It is used in powder form, without pre-drying step. The additives indicated in the tables below are mixed to the LDPE powder and the mixture is compounded in a lab scale twin-screw mini-extruder (Xplore Instruments B.V.) with co-rotating screws and volume of 15 cm³ in a loop system during three minutes at constant screw rotating speed (100 rpm) under Nitrogen blanket. The percentages given below are weight percent. The melt temperature is 174° C.+2° C. After three minutes the by-pass is opened so that the melt can be collected. The melt is left at room temperature to cool down. The compounded LDPE is then cut to a bit of 2.5 g, placed in a hot press between two Teflon sheets and compression molded at 180° C. (press temperature) during a total duration of three minutes, with pressure of 0 bar during 1 minute, then 5 bar during 1 minute, then 45 bar during 1 minute. Then the compression molded sample is taken out and cooled at room temperature. This method enables to obtain a compression molded sample with thickness of roughly 150 micron.

Then the compression molded sample is cut to the quantity as indicated in the below tables and placed in a glass bottle of volume as indicated in the below tables, with an oxygen sensor, and hermetically closed. The amount of oxygen scavenged by the test samples is determined from the change in the oxygen concentration in the head space of the glass container. The glass containers with test samples are stored at 23° C. At known time intervals, as indicated in the below corresponding tables, the oxygen concentration is measured by applying the OpTech O₂ apparatus (Mocon GmbH) onto the bottle at the position of the sensor. The oxygen concentration has an initial value close to 21%, the typical oxygen concentration in air, and then decreases over time (measurements typically performed up to 28 days) due to the scavenging action of the additives incorporated into the LDPE compounds. Knowing the bottle volume in ml and the concentration of the additives in the LDPE sample, the quantity of scavenged oxygen into ml O₂ scavenged per gram scavenger can be determined according to the following equation:

Scavenged oxygen (ml/g)={(% O₂)ᵢ—(% O₂)_{f}}*0.01*Vⱼ/(W_{F}*0.01*C_{S})

where:

(% O₂)ᵢ Initial oxygen concentration in the glass container (%);

(% O₂)_{f} Oxygen concentration in the glass container at time of test (%)

0.01: Conversion factor

Vⱼ: Free air volume of the glass container (ml)

W_{E}: Weight of film placed into the glass container (g)

Cₛ: Concentration of oxygen scavenger in film (%)

In addition, the L*, a* and b* color features of the samples are measured (apparatus Micro Color II from Dr. Bruno Lange GmbH), with a white background. In order to obtain the intrinsic color features of the samples, with as little possible influence from the white background, a total of 8 layers of each samples are measured. This stapling ensures that the transparency is reduced close to zero. L*, a* and b* are as defined in EN ISO 11664-4:2008 (“Colorimetry—Part 4: CIE 1976 L*a*b* Colour space”).

The Transmittance and Haze are measured on one layer of the sample, with an apparatus haze-gard plus from BYK-Gardner GmbH, according to ASTM D 1003.

The recipes and results are given in the following tables.

TABLE 1

| | *⁾ ml O₂/g scavenger ml/g | | | | |
|---|---|---|---|---|---|
| Number of days | 0 | 3 | 7 | 14 | 28 |
| Oxygen scavenger | | | | | |
| 0.2% of Product 1 + | 0 | 7.4 | 12.3 | 13.6 | 24.9 |
| 0.2% of Mn stearate + | | | | | |
| 2% of Polyterpene 1 | | | | | |
| 0.4% of Product 1 + | 0 | 6.9 | 13.3 | 16.1 | 40.8 |
| 0.2% of Mn stearate + | | | | | |
| 2% of Polyterpene 1 | | | | | |
| 0.2% of Product 2 + | 0 | 8.9 | 15.5 | 19.3 | 34.8 |
| 0.2% of Mn stearate + | | | | | |
| 2% of Polyterpene 1 | | | | | |
| 0.4% of Product 2 + | 0 | 5.6 | 13.6 | 33.3 | 77.2 |
| 0.2% of Mn stearate + | | | | | |
| 2% of Polyterpene 1 | | | | | |

*⁾ High values are desired.
Polyterpene 1: Polyterpene (softening point of 125° C.) based on beta-pinene.
Amount of polymer film: 5 g.
Volume of glass bottle: 100 ml.

TABLE 2

| | *⁾ ml O₂/g scavenger [ml/g] | | | | | |
|---|---|---|---|---|---|---|
| | Number of days | | | | | |
| Additives | 0 | 2 | 5 | 7 | 14 | 21 |
| 0.2% of Product 1 + | 0 | 40.0 | 88.7 | 113.0 | 148.7 | 171.3 |
| 0.1% of Mn stearate + | | | | | | |
| 2% of Polyterpene 2 | | | | | | |
| 0.2% of Product 1 + | 0 | 36.3 | 85.4 | 120.0 | 170.0 | 181.7 |
| 0.2% of Mn stearate + | | | | | | |
| 2% of Polyterpene 2 | | | | | | |
| 0.2% of Product 2 + | 0 | 40.0 | 93.9 | 124.8 | 165.2 | 181.7 |
| 0.1% of Mn stearate + | | | | | | |
| 2% of Polyterpene 2 | | | | | | |
| 0.2% of Product 2 + | 0 | 51.3 | 111.3 | 141.7 | 181.7 | 181.7 |
| 0.2% of Mn stearate + | | | | | | |
| 2% of Polyterpene 2 | | | | | | |

*⁾ High values are desired.
Polyterpene 2: Polyterpene (softening point of 115° C.) based on alpha-pinene.
Amount of polymer film: 5 g.
Volume of glass bottle: 100 ml.

TABLE 3

| | ¹⁾Transmittance | ²⁾Haze | | | |
|---|---|---|---|---|---|
| Additives | [%] | [%] | L* | a* | b* |
| 0.2% of Product 1 + | 92.2 | 42.6 | 75.2 | −0.3 | 2.8 |
| 0.1% of Mn stearate + | | | | | |
| 2% of Polyterpene 2 | | | | | |
| 0.2% of Product 1 + | 92.4 | 38.1 | 74.7 | −0.8 | 4.4 |
| 0.2% of Mn stearate + | | | | | |
| 2% of Polyterpene 2 | | | | | |
| 0.2% of Product 2 + | 92.2 | 42.4 | 75.0 | 0.0 | 3.4 |
| 0.1% of Mn stearate + | | | | | |
| 2% of Polyterpene 2 | | | | | |
| 0.2% of Product 2 + | 91.7 | 33.4 | 74.9 | −0.8 | 4.1 |
| 0.2% of Mn stearate + | | | | | |
| 2% of Polyterpene 2 | | | | | |

¹⁾High values are desired.
²⁾Low values are desired.

1. An additive mixture comprising
(I) a copolymer having a number average molecular weight of 800 g/mol to 50 000 g/mol and containing recurring units of the formula (Ia) and (IIa) or recurring units of the formula (Ia) and (IIb), 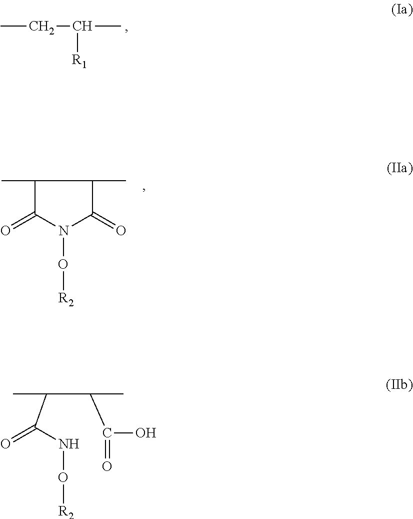
wherein
the recurring units (Ia) and (IIa) can have a random, alternating or block distribution and the molar ratio of (Ia) to (IIa) is 1:10 to 10:1,
the recurring units (Ia) and (IIb) can have a random, alternating or block distribution and the molar ratio of (Ia) to (IIb) is 1:10 to 10:1,
the radicals R₁ independently of one another are C₁₀-C₃₀alkyl and
the radicals R₂ independently of one another are hydrogen or C₁-C₃₀acyl,
(II) a metal salt, preferably a transition metal salt, and
(III) an oxidizable substrate,
with the proviso that components (I) and (III) are different.

2. The additive mixture according to claim 1, wherein R₂ is hydrogen, C₁₀-C₃₀alkanoyl or C₁₀-C₃₀alkenoyl, preferably hydrogen or C₁₆-C₂₄alkanoyl, in particular hydrogen or stearoyl.

3. The additive mixture according to claim 1, wherein component (II) is an organic salt of Fe, Co, Ce, Mn, Cu, Ni or Vd, preferably of Cu, Co or Mn, in particular Mn.

4. The additive mixture according to claim 1, wherein component (II) is a metal salt of a C₆-C₃₆carboxylic acid.

5. The additive mixture according to claim 1, wherein component (III) is selected from the group consisting of polybutadiene, polyester, squalane, squalene, polystyrene, poly-limonene, poly alpha pinene, poly beta pinene, poly-norbornene, polylactic acid and a mixture of linear and branched alkyl chain C₆-C₃₀alcohols.

6. The additive mixture according to claim 1, wherein component (III) is a polyterpene resin, preferably a polyterpene based on an alpha-pinene or a beta-pinene, in particular a polyterpene based on beta-pinene.

7. A composition containing components (A), (B) and optionally (C), wherein
(A) is a polymeric resin, preferably a thermoplastic polymeric resin,
(B) is the additive mixture according to claim 1, and
(C) is a further additive, preferably an additive selected from the group consisting of nucleating agents, clarifiers, fillers, reinforcing agents, pigments, dyestuffs, light stabilizers, antioxidants, antifogging agents, antislip or antiblock additives, plasticizers, flame retardants, optical brighteners, photoinitiators, antistatic agents and blowing agents,
with the proviso that the additives of components (B) and (C) are different.

8. The composition according to claim 7, wherein component (A) is selected from the group consisting of homo- or copolymers of olefin monomers, copolymers of olefin monomers with diolefin monomers, cyclic olefins, copolymers of one or more 1-olefins and diolefins with carbon monoxide, polyvinyl alcohol, polyamide, polybutylene terephthalate, polyethylene terephthalate, poly(butylene adipate-co-terephthalate) and polybutylene succinate.

9. The composition according to claim 7, wherein component (A) is selected from the group consisting of acrylates, urethanes, epoxies, polyesters, polystyrenics, polybutadiene, polyisoprene and their copolymers.

10. The composition according to claim 7, wherein the pigment is titanium dioxide and the clarifier is a sorbitol, an organic phosphate salt or a trisamide.

11. The composition according to claim 7, wherein component (B) is present in an amount of 0.001 to 20%, preferably 0.01 to 10%, in particular 1 to 5%, relative to the weight of component (A).

12. A shaped polymer article made of the composition according to claim 7.

13. The shaped polymer article according to claim 12, which is a film, a tape, a sheet, a laminate, an injection molded article, a blow molded article, a thermoformed article, a particle (powder) or a fiber.

14. The shaped polymer article according to claim 12, which is an extruded film or a coextruded multilayer film.

15. The shaped polymer article according to claim 12, which is a food packaging.

16. The use of the additive mixture according to claim 1 as oxygen scavenger, dispersant, compatibilizer, coupling agent, antistatic additive, oxygen barrier additive, water vapor barrier additive, pour-point depressant, flow modifier for crude oil, dish-washing detergent, antifouling agent in water systems, binder, metal deactivator or thermal stabilizer, preferably as oxygen scavenger.

17. A copolymer having a number average molecular weight of 800 g/mol to 50 000 g/mol and containing recurring units of the formula (Ia) and (IIa) or recurring units of the formula (Ia) and (IIb), 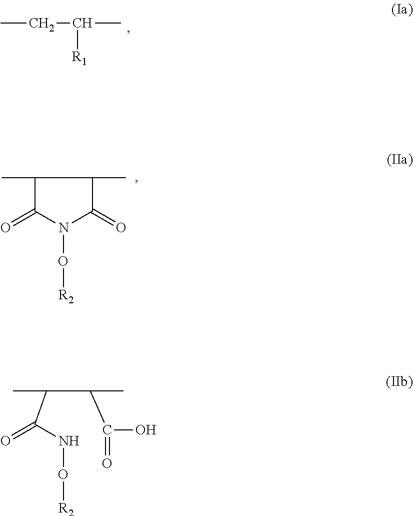
wherein
the recurring units (Ia) and (IIa) can have a random, alternating or block distribution and the molar ratio of (Ia) to (IIa) is 1:10 to 10:1,
the recurring units (Ia) and (IIb) can have a random, alternating or block distribution and the molar ratio of (Ia) to (IIb) is 1:10 to 10:1,
the radicals R₁ independently of one another are C₁₀-C₃₀alkyl and the radicals R₂ independently of one another are hydrogen or C₁-C₃₀acyl,
with the proviso, that R₂ is not hydrogen in the recurring unit of formula (IIa).
